(19) United States
(12) Patent Application Publication
(10) Pub. No.: US 2025/0093659 A1
(43) Pub. Date: Mar. 20, 2025

(54) ELONGATED COLLIMATOR FOR PUPIL PLACEMENT

(71) Applicant: GOOGLE LLC, Mountain View, CA (US)

(72) Inventors: Ozan Cakmakci, San Mateo, CA (US); Oscar Alberto Martinez, San Diego, CA (US)

(21) Appl. No.: 18/884,794

(22) Filed: Sep. 13, 2024

Related U.S. Application Data
(60) Provisional application No. 63/538,624, filed on Sep. 15, 2023.

(51) Int. Cl. G02B 27/01; G02B 27/00

(52) U.S. Cl. CPC G02B 27/0172; G02B 27/0081; G02B 2027/013; G02B 2027/0178

(57) ABSTRACT

An elongated collimator collimates light generated by a microdisplay for coupling to an exit pupil expander of a waveguide. The elongated collimator includes a first portion having four or more freeform surfaces that fold the optical path of the light and then direct the light via total internal reflection through an elongated flat (or nearly flat) second portion of the collimator to form a pupil within a lens of an eyewear display device. The elongated collimator delivers collimated light to a pupil located toward the center of the lens where the light can be collected by an exit pupil expander having a relatively small footprint.

### BACKGROUND

Augmented reality (AR) eyewear fuses a view of the real world with a heads-up display overlay. Eyewear display devices, also referred to as wearable heads-up displays (WHUDs), are wearable electronic devices that use optical combiners to combine real world and virtual images. The optical combiner may be integrated with one or more lenses to provide a combiner lens that may be fitted into a support frame of an eyewear display device. In operation, the combiner lens provides a virtual display that is viewable by a user when the eyewear display device is worn on the head of the user.

One class of optical combiner uses one or more waveguides (also termed lightguides) to transfer light. In general, light from a projector, microdisplay, or other light engine of the eyewear display device enters a waveguide of the combiner through an incoupler, propagates along the waveguide via total internal reflection (TIR), and exits the waveguide through an outcoupler. If a pupil of a user's eye is aligned with one or more exit pupils provided by the outcoupler, at least a portion of the light exiting through the outcoupler will enter the pupil of the user's eye, thereby enabling the user to see a virtual image. Since the optical combiner is substantially transparent, the user will also be able to see the real world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display device employing an elongated collimator that collimates light and places a pupil within a lens for transfer to an exit pupil expander of an optical waveguide through which images projected by the eyewear display device are displayed, in accordance with some embodiments.

FIG. 2 shows an example elongated collimator in accordance with some embodiments.

FIG. 3 shows an example elongated collimator placing a pupil within a spherical lens in accordance with some embodiments.

FIG. 4 shows an example elongated collimator and an exit pupil expander embedded within a spherical lens in accordance with some embodiments.

FIG. 5 is a flow diagram of a method of collimating light from a microdisplay at an elongated collimator and placing a pupil of the collimated light within a lens for transfer to an exit pupil expander of a lightguide in accordance with some embodiments.

### DETAILED DESCRIPTION

The development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

For a virtual image displayed at an eyewear display device to be clear and have a relatively large FOV, light generated by the projector, micro-display, or other light engine of the eyewear display device is collimated (i.e., made to have parallel or nearly parallel light beams) before the light is coupled into an exit pupil expander. If the collimated light forms a pupil that is located at or near a temple area of an eyewear display device for collection by an exit pupil expander, the exit pupil expander must be relatively large to form an image at a relatively large eyebox having a relatively large FOV.

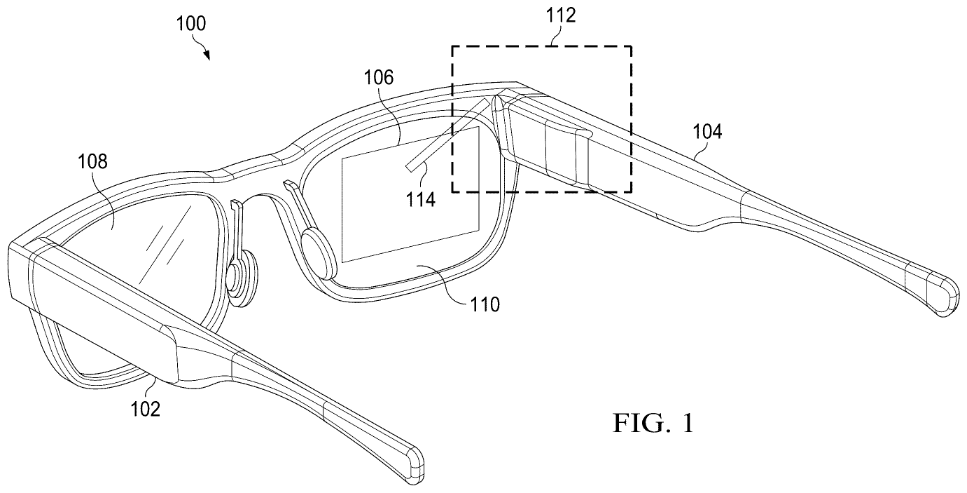

FIGS. 1-5 illustrate systems and techniques for collimating light generated by a light engine for coupling to an exit pupil expander of a waveguide using an elongated collimator having four or more freeform surfaces that fold the optical path of the light, resulting in a compact design, and then direct the light via TIR through an elongated flat (or nearly flat) portion of the collimator to form a pupil within a lens of an eyewear display device. The term “freeform” refers to a surface that does not have symmetry around any axis. In some embodiments, the freeform surfaces are toroidal surfaces made from a single injection-molded element, such as a single piece of plastic. The freeform surfaces collimate the light and direct the light through the elongated portion of the collimator so the collimated light is delivered to a pupil located toward the center of the lens where the light can be collected by an exit pupil expander having a relatively small footprint. In some embodiments, the elongated portion of the collimator is substantially flat, such that substantially no optical power is conferred on the light rays passing through the collimator. In other embodiments, the elongated portion of the collimator is sufficiently curved to expand the pupil without adversely affecting image quality.

FIG. 1 illustrates an example eyewear display system 100 (referred to as display system 100) employing an elongated collimator 114 in accordance with some embodiments. The display system 100 has a support structure 102 that includes an arm 104, which houses a projector (e.g., a laser projector, a micro-LED projector, a Liquid Crystal on Silicon (LCOS) projector, or the like), also referred to herein as a microdisplay. The projector is configured to project images toward the eye of a user via a lightguide, such that the user perceives the projected images as being displayed in a field of view (FOV) area 106 of a display at one or both of spherical lens elements 108, 110. In the depicted embodiment, the display system 100 is a near-eye display system in the form of an eyewear display device in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a lightguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the spherical lens elements 108, 110 are used by the display system 100 to provide an augmented reality (AR) display in which rendered graphical content can be superimposed over or otherwise provided in conjunction with a real-world view as perceived by the user through the spherical lens elements 108, 110. For example, a projection system of the display system 100 uses light to form a perceptible image or series of images by projecting the light onto the eye of the user via a projector of the projection system, the elongated collimator 114, a lightguide including an exit pupil expander formed at least partially in the corresponding spherical lens element 108 or 110, and one or more optical elements (e.g., one or more scan mirrors, or one or more optical relays, that are disposed between the projector and the lightguide), according to various embodiments. In some embodiments, the elongated collimator 114 supports full color and a path to a large eyebox by coupling with an exit pupil expander.

One or both of the spherical lens elements 108, 110 includes at least a portion of the elongated collimator 114 and a lightguide that routes display light received by an incoupler of the lightguide to an outcoupler of the lightguide, which outputs the display light toward an eye of a user of the display system 100. The display light is modulated and projected onto the eye of the user such that the user perceives the display light as an image. In addition, each of the spherical lens elements 108, 110 is sufficiently transparent to allow a user to see through the spherical lens elements to provide a field of view of the user's real-world environment such that the image appears superimposed over at least a portion of the real-world environment.

In some embodiments, the projector of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the projector includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the projector includes a Liquid Crystal on Silicon (LCOS) display panel. In some embodiments, a display panel of the projector is configured to output light (representing an image or portion of an image for display) into the lightguide of the display system via the elongated collimator 114. The lightguide expands the light and outputs the light toward the eye of the user via an outcoupler.

The display system 100 may include a processor (not shown) that is communicatively coupled to each of the electrical components in the display system 100, including but not limited to the projector. The processor can be any suitable component which can execute instructions or logic, including but not limited to a micro-controller, microprocessor, multi-core processor, integrated-circuit, ASIC, FPGA, programmable logic device, or any appropriate combination of these components. The display system 100 can include a non-transitory processor-readable storage medium, which may store processor readable instructions thereon, which when executed by the processor can cause the processor to execute any number of functions, including causing the projector to output light representative of display content to be viewed by a user, receiving user input, managing user interfaces, generating display content to be presented to a user, receiving and managing data from any sensors carried by the display system 100, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components. The projector outputs light toward the FOV area 106 of the display system 100 via the lightguide.

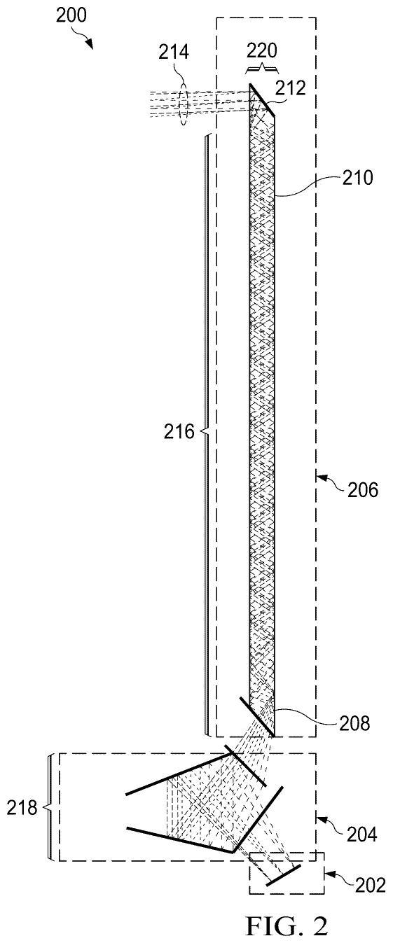

FIG. 2 shows an example elongated collimator 200 in accordance with some embodiments. The elongated collimator 200 includes a first portion 204 and a second portion 206. In the illustrated example, the first portion 204 includes four freeform surfaces that collectively receive light from a microdisplay 202 and collimate the light into substantially parallel beams. The second portion 206 is relatively long and thin, and includes multiple surfaces that collectively encourage propagation of the collimated light by total internal reflection (TIR) from an end of the second portion 206 that is proximal to the first portion 204 (referred to as proximal end 208) toward a distal end 210 of the second portion 206. The light at the distal end 210 of the second portion 206 reflects off a mirror 212 to form a pupil 214 for input to an exit pupil expander (not shown).

The second portion 206 has a length 216 that is longer than a length 218 of the first portion 204. For example, in some embodiments, the length 216 of the second portion 206 is at least 10 (or 20, or 25) times the length 218 of the first portion 204. In addition, in some embodiments, the length 216 of the second portion 206 is many times (e.g., 25 times) longer than a width 220 of the second portion 206. For example, in some embodiments, the width 220 of the second portion 206 is approximately 1 mm, and the length 216 of the second portion 206 is approximately 25 mm. The elongated second portion 206 of the elongated collimator 200 extends into a lens, such as lens elements 108, 110 of FIG. 1, to deliver the pupil 214 to the exit pupil expander at or near the center of the lens. By providing the pupil 214 at or near the center of the lens, the elongated collimator 200 enables the eyewear display device 100 to provide a larger FOV and eyebox using a smaller exit pupil expander than a conventional collimator that does not extend into the lens.

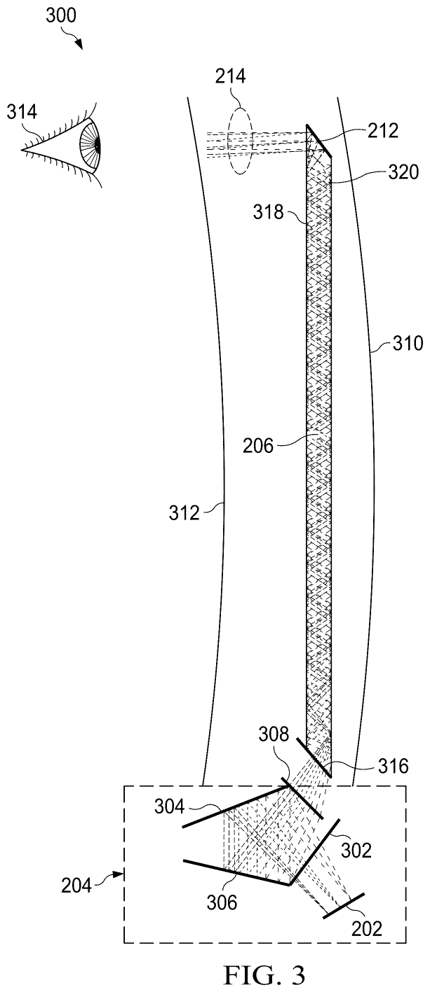

FIG. 3 shows an example 300 of the elongated collimator 200 placing the pupil 214 within a spherical lens for delivery to an exit pupil expander (not shown) in accordance with some embodiments. The first portion 204 of the elongated collimator 200 includes four freeform surfaces that collectively collimate light emitted by the microdisplay 202. In some embodiments, the first portion 204 includes a first freeform surface 302, a second freeform surface 304, a third freeform surface 306, and a fourth freeform surface 308. In some embodiments, at least one of the first freeform surface 302, the second freeform surface 304, the third freeform surface 306, and the fourth freeform surface 308 is a toroid. In the illustrated example, the first freeform surface 302 is disposed opposite the second freeform surface 304 and adjacent to the third freeform surface 306 and the fourth freeform surface 308, which are disposed opposite each other.

In operation, light emitted from the microdisplay 202 refracts through the first freeform surface 302. The light is then reflected off the second freeform surface 304 toward the third freeform surface 306. The third freeform surface 306 receives light reflected off the second freeform surface 304 and in turn reflects the light toward the fourth freeform surface 308. The fourth freeform surface 308 refracts the light received from the third freeform surface 306 out of the first portion 204 toward the second portion 206 in substantially parallel beams.

In some embodiments, the shapes of each of the first freeform surface 302, the second freeform surface 304, the third freeform surface 306, and the fourth freeform surface 308 are described by a height (also referred to as a sag) z from each point (x,y) along a plane, wherein r is a base sphere term and j is an index:

$$Z = \frac{c {r}^{2}}{1 + \sqrt{1 - ( 1 + k ) {c}^{2} {r}^{2}}} + {\sum }_{j = 2}^{66} {C}_{j} {x}^{m} {y}^{n} \qquad ( 1 )$$

$$where j = \frac{{( m + n )}^{2} + m + 3 n}{2} + 1 \qquad ( 2 )$$

Thus, for example, in the case of a toroid, if m=2 and n=0, j=4, and if m=0 and n=2, j=6. In some embodiments, the coefficients used in equations (1) and (2) differ for each of the first freeform surface 302, the second freeform surface 304, the third freeform surface 306, and the fourth freeform surface 308. The first freeform surface 302, the second freeform surface 304, the third freeform surface 306, and the fourth freeform surface 308 are sized and spaced relative to one another such that substantially all of the light rays emitted from the microdisplay 202 propagate through the first portion 204 of the elongated collimator 200 and are emitted in substantially parallel rays through the fourth freeform surface 308 to the second portion 206 of the elongated collimator 200.

Light enters the second portion 206 of the elongated collimator 200 in substantially parallel beams and travels through the second portion 206 via TIR toward the distal end 210 to form the pupil 214 for transfer to the exit pupil expander. In some embodiments, the second portion 206 of the elongated collimator 200 acts as a waveguide that includes four surfaces: an input surface 316 at the proximal end 208 to receive the collimated light from the first portion 204, an eye-facing surface 318 that faces an eye 314 of a user when the eyewear display device 100 is worn by the user, a world-facing surface 320 that faces away from the user when the eyewear display device 100 is worn by the user, and the mirror 212 to direct light out of the second portion 206 toward the exit pupil expander. In some embodiments, each of the surfaces 316, 318, 320, 212 is substantially flat. In such embodiments, the second portion 206 of the elongated collimator 200 confers substantially no optical power on the light as it travels through the second portion 206, and the light at the pupil 214 remains collimated.

In other embodiments, one or more of the surfaces 316, 318, 320, 212 is curved, such that optical power is distributed along the second portion 206. In some embodiments, the optical power increases the size of the pupil 214 such that a larger pupil 214 is output to the exit pupil expander than a pupil that is transferred from the first portion 204 to the second portion 206 of the elongated collimator 200.

In the illustrated example, the second portion 206 of the elongated collimator 200 is embedded within a spherical shell having a world-facing surface 310 and an eye-facing surface 312. The spherical shell provides optical see-through such that the user can view the environment. In other words, the spherical shell provides the user with a real-world view. In some embodiments, the second portion 206 of the elongated collimator 200 is embedded inside the spherical shell using either a material-air interface or a high refractive index and low refractive index material pair to encourage TIR. In cases in which the high refractive index and low refractive index material pair is used, the low refractive index interface may be implemented by either a vacuum coating such as chiolite or etched nanostructures in plastic. In some embodiments, the elongated collimator 200 and the spherical shell are formed using plastic materials combined with injection molding.

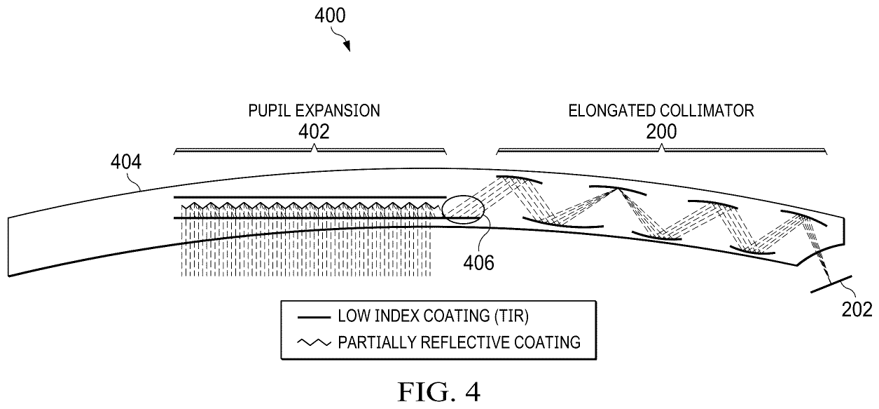

FIG. 4 shows an example 400 of the elongated collimator 200 and an exit pupil expander 402 embedded within a spherical lens 404 in accordance with some embodiments. In the illustrated example, the microdisplay 202 emits display light toward the elongated collimator 200. In some embodiments, the microdisplay 202 is disposed within a temple portion of a frame of an eyewear display device such as the support structure 102 of eyewear display device 100. The elongated collimator 200 receives the display light at the input surface and collimates the display light at the first portion. The collimated display light then travels along the long, thin second portion to form a pupil 406 that is transferred to the exit pupil expander 402.

The exit pupil expander expands the display light using prism structures that are coated with a partially reflective coating and couples the light out of the spherical lens 404. The spherical lens 404 allows light from the environment to pass through the spherical lens such that a user is also provided with a real-world view in addition to images formed by the display light. By extending the elongated collimator 200 into the spherical lens 404, the exit pupil expander 402 can receive the pupil without extending as far into the spherical lens 404, thus reducing the footprint of the exit pupil expander. In particular, the long, thin second portion of the elongated collimator 200 delivers the pupil 406 at or near the center of the spherical lens 404 (i.e., nearer to the eye of a user). The exit pupil expander 402 can be made smaller than if the pupil 406 were closer to the temple portion of the frame while still producing a relatively large FOV. The smaller exit pupil expander 402 reduces the thickness of the eyewear display device while maintaining a relatively large eyebox.

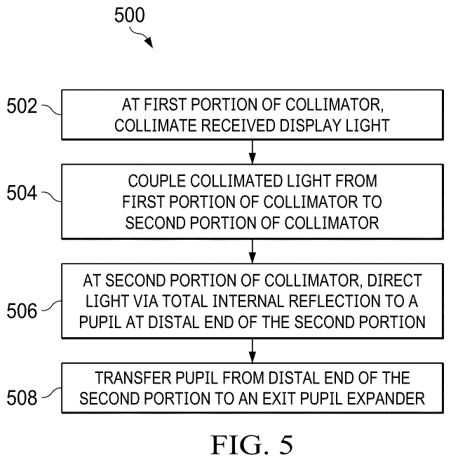

FIG. 5 is a flow diagram of a method 500 of collimating light from a microdisplay at an elongated collimator and placing a pupil of the collimated light within a lens for transfer to an exit pupil expander of a lightguide in accordance with some embodiments. In some embodiments, the method 500 is performed by an elongated collimator such as elongated collimator 200.

At block 502, display light is received from a microdisplay such as microdisplay 202 and collimated at the first portion 204 of the elongated collimator 200. In some embodiments, light emitted from the microdisplay 202 refracts through the first freeform surface 302 and is then reflected off the second freeform surface 304 toward the third freeform surface 306. The third freeform surface 306 receives light reflected off the second freeform surface 304 and in turn reflects the light toward the fourth freeform surface 308. The fourth freeform surface 308 refracts the light received from the third freeform surface 306 out of the first portion 204 toward the second portion 206 in substantially parallel beams.

At block 504, light from the first portion 204 of the elongated collimator 200 is coupled to the second portion 206 of the elongated collimator 200. In some embodiments, the light is coupled to the second portion 206 via the surface 316.

At block 506, collimated light received at the second portion 206 of the elongated collimator 200 is directed through the second portion 206 from the proximal end 208 to the distal end 210 of the second portion 206 via TIR. In some embodiments, the surfaces of the second portion 206 are substantially flat and confer substantially zero optical power to the light. In other embodiments, one or more surfaces of the second portion 206 are curved and distribute optical power along the length 216 of the second portion 206. The amount of curvature of the one or more surfaces of the second portion is limited to a threshold to minimize distortion of the image quality of the light.

At block 508, the second portion 206 transfers a pupil such as pupil 214 from the distal end 210 of the second portion 206 to an exit pupil expander such as exit pupil expander 402. In some embodiments, the pupil 214 is transferred to the exit pupil expander at or near the center of the spherical lens 108, 110 of an eyewear display device such as eyewear display device 100.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display device, comprising:
a collimator comprising:
a first portion having a first length and comprising a plurality of freeform surfaces configured to collimate display light generated by a microdisplay; and
a second portion having a second length longer than the first length and comprising a waveguide configured to guide the display light from the first portion to a pupil at a distal end of the second portion.

2. The eyewear display device of claim 1, further comprising:
an exit pupil expander configured to receive the pupil and expand the display light.

3. The eyewear display device of claim 1, wherein the second length is more than ten times longer than the first length.

4. The eyewear display device of claim 1, wherein the waveguide comprises four waveguide surfaces.

5. The eyewear display device of claim 4, wherein one or more of the waveguide surfaces is flat.

6. The eyewear display device of claim 4, wherein one or more of the waveguide surfaces is curved.

7. The eyewear display device of claim 1, further comprising:
a frame; and
a lens comprising a spherical shell disposed within the frame, wherein the second portion of the collimator is embedded within the spherical shell.

8. The eyewear display device of claim 7, wherein the microdisplay is disposed within the frame.

9. A method, comprising:
collimating display light generated by a microdisplay at a first portion of a collimator, the first portion having a first length; and
guiding the collimated display light along a second portion of the collimator having a second length that is longer than the first length of the first portion to form a pupil at a distal end of the second portion.

10. The method of claim 9, further comprising:
receiving the pupil and expanding the display light at an exit pupil expander.

11. The method of claim 9, wherein the second length is more than ten times longer than the first length.

12. The method of claim 9, wherein the second portion comprises four surfaces.

13. The method of claim 12, wherein one or more of the surfaces is flat.

14. The method of claim 12, wherein one or more of the surfaces is curved.

15. The method of claim 9, further comprising:
a frame; and
a lens comprising a spherical shell disposed within the frame, wherein the second portion of the collimator is embedded within the spherical shell.

16. The method of claim 15, wherein the microdisplay is disposed within the frame.

17. An eyewear display device, comprising:
a frame;
a lens comprising a substantially spherical shell disposed within the frame;
a microdisplay disposed within the frame to generate display light; and
an elongated collimator comprising:
a first portion having a first length and comprising a plurality of freeform surfaces configured to collimate the display light; and
a second portion having a second length longer than the first length and configured to guide the display light from the first portion to a pupil at a distal end of the second portion.

18. The eyewear display device of claim 17, further comprising:
an exit pupil expander configured to receive the pupil and expand the display light.

19. The eyewear display device of claim 17, wherein the distal end of the second portion is at or near the center of the lens.

20. The eyewear display device of claim 17, wherein the second portion confers less than a threshold amount of optical power to the display light.
